(19) United States
(12) Patent Application Publication
(10) Pub. No.: US 2026/0177026 A1
(43) Pub. Date: Jun. 25, 2026

(54) A PERIPHERAL EXPANDING CHAMBERS IN FLYWHEEL ENGINE GENERATING AND STORING ENERGY

(71) Applicant: Peter GRANER, Kfar Saba (IL)

(72) Inventor: Peter GRANER, Kfar Saba (IL)

(21) Appl. No.: 19/129,079

(22) PCT Filed: Nov. 13, 2023
(86) PCT No.: PCT/IL2023/000001

§ 371 Date: May 12, 2025

(30) Foreign Application Priority Data
Nov. 13, 2022 (IL) 298179

(51) Int. Cl. F03B 13/08; F02C 7/00; H02K 7/02; H02K 7/18

(52) U.S. Cl. CPC F03B 13/08; F02C 7/00; H02K 7/025; H02K 7/1823

(57) ABSTRACT

The present invention relates to a Flywheel Engine utilizing Flywheel with Peripheral Multiple Expanding Chambers, powered by Energies generation, each of which are used for accommodate one or more: Compressed Air, Hydrogen/generation, Water, Steam/generation, Energies Storage and Energies Supplies (CAHWSESES), creates combinations of Energies Supplies. When combining mixing of Pressurized Air and Water suppling Aeration water, integrated in hot Water/Solar Steam generation apparatuses, used for storing solar electricity or from grid electricity. moreover, combined with high pressure Air and Residual heat integrate Compressed Air with Residual Water, Hydrogen generation, using Solar PV electric and Solar Thermal energies. An innovative breakthrough technology, where the energies are channeled into peripheral expanding chambers, combined with fluid jets attached to a flywheel (CAHWS), and integrate with Electric Generator/Alternator, as well as mechanical energy output, which multiplying the energies that is exist/supplied today in the world market, defined as energies supplied from Energies Storage systems and generate various electricity and hot water generation system (e.g. about 2 times and more). Moreover, innovative Energies Storage and Energies Supplies with all mechanical systems have a lifespan of at least, 2 generations with the price lower than acid/salt batteries or lithium batteries or any other Energy storage Energy Supply, and this without the needs for chemical tanks.

Innovations without the need for:
1. Heat pumps for DHWS.
2. Gas, Diesel, Mechanical combustion fossil Gasoline Engine and Electric diesel fuel generator.
3. EV/Storage Lithium batteries.
4. Mechanical elevations/lifting storage.

As described above, currently available on the world market.

### FIELD OF THE INVENTION

The present invention relates to a Flywheel Engine utilizing Flywheel with Peripheral Multiple Expanding Chambers, characterized by structure of a triangle Arc and rectangular, when on the outer arc positioned around an static chambers and conical fluids jets coupled to arc brackets, powered by each of which is used for accommodate one or more fluids: Compressed Air, Hydrogen generation, Water Steam generation Energies Storage and Energies Supplies (CAHWSESES), creates combinations of Solar Energies (option from any source or Grid supply) generations and supplies.

Perfect solution for creating the Four-Ultra-Hybrid Solar Energies Generation, Storages and Supplies:

1. Multiplications capacity of Energies generation, integrated with Peripheral Multiple Expanding Chambers in Flywheel Engine/s using (CAHWS), Energies Storage, Energies Supply in small space and small foot print 2. High Booster of DC or AC to charge EVehicle. 3. Electricity for domestic/commercial processing instead of gas and Etc. 4. Hot water for Hybrid Air Conditioners, various uses as DHW and commercial uses. With the aim of providing a solution to the urban, commercial areas, where most of the energies are really consumed by plurality end user, such as well as from Residual hot waters supplies (unnecessary for water Heat Pumps or heating by gas for cooking or other heating needs for), and a perfect replacement for lithium batteries and standard hot water Sunray collectors, as well as other various Energies Producers/Suppliers. The present invention using Energies Generation/Storage, integrated in a Novel Flywheel with Peripheral Multiple Expanding Chambers overlapping with conical fluids jets, creating the Flywheel Engine/s, integrate with Electric Generator/Alternator/Mechanical output, comprising of: erecting configuration of elongated chambers in the form of a hole with open end cut, characterized by structure of a triangle Arc and rectangular in the Flywheel/s, erecting configuration of overlapping each other and together elongating with Static chambers in a Triangle Arc and Rectangular structure, forming Peripheral Multiple Expanding Chambers overlapping with static chambers and fluids jets in the Flywheel Engine, described as for example: “a telescopic cylinder” powered/feed from each of which is used for accommodate one or more Compressed Air, Hydrogen generation, Water, and Steam generation Energy Storage and Energies Supplies (CAHWSESES), drives an Electric Generator/Alternator, as well as define and form the Hybrid Peripheral Expanding Chambers in Flywheel Compressed Air, and integrate Hydrogen explosion Peripheral Flywheel Engine/s used for: as for various vehicles, replace mechanical engine and etc., combustion Vehicles/mechanical output, generators, fork lift and Etc. Moreover, using the Pressurized system of Water with Air, configuring Aerations erected with Venturi, generating steam, integrated pressurizing pump of Water/Air and additionally, integrate High Air pressurizer Mixing into Multiple Conical Booster define as Solar Steam collector, generate Residual High pressurized Solar Steam generation, combine in Pre-Compressed Air to generate/produce pressurized Hydrogen generation, as well as compressed Air which create improvement by multiples highest levels generating of: Electricity, Hot water, Heat, utilizing Residual Hydrogen generation so that they form various Energies, Energies Storage, mechanical output and various Energies Supplies.

### BACKGROUND OF THE INVENTION

In the near future Electricity Storage generated by Solar PV and PVT panels, Wind turbine, Wave Energy, Geothermal Electric Generators and etc. relies on various means systems of low efficiency and short energy supply period as: lithium batteries (˜90% with yearly degradation of ˜3%), compressed Water/Air (˜40%), multiple-level pumped water energy storage and other energy storage technologies. On the other hand, using Compressed Air or Air and Hydrogen generating Peripheral Multiple Expanding Chambers (hole) and combustion/explosions Chambers in Flywheel Engine for vehicles, Trains, Ships, Air craft etc. may become the main means of transportation as well as by using Peripheral Multiple Expanding Chambers in Flywheel Engine integrated with Electric Generator/Alternator and mechanical output, as various Air motor for Vehicles, combustion Vehicles/generators and Etc., instead of manufactured with an electric motor with electric battery energy supply, Air (cylinder/piston and valve/wankel) Engines vehicles, combustion fossil engine and Etc.

Several systems have been proposed/exist, aimed to store and supply electricity as compressing air with pressurizing water, Flywheel free energy, Flywheel kinetic mechanism's and thermal energy (such as Heat Pump) supply energy for various consumers. Therefore, such a field of the energies systems integrated with flywheel engine generator of: Peripheral multiple Expanding Chambers in Flywheel Engine integrated with Electric Generator powered by Compressed Air and residual heat Hydrogen generation Solar Thermal generation Water Energies Storage and Energies Supplies PCFEEGCAHSTWESES facility, simultaneously capable to supply a large amount of VERY high capacity (Booster) of DC or AC electrical power, i.e. high Voltage, high Direct Current (DC), (e.g. 100 kilowatt per hour (KWh) and higher wherein average ONE UNIT can supply, as well as Electric 80 KWh Storage of 1.5MW+Thermal 130 KWh Energy within space of ˜13 Cubic meters), as well as producing Hydrogen by using high pressure Residual Air Water. Presently the storage and generated electricity is typically supplied with low efficiency from long distance AC supply electrical grids, supplied from distant various power plants and several times converting of high voltage to low voltage, transference through several relay stations and transformers, among others: fuels, oil, coal, gas and carbon.

Several systems such as compressed water utilizing compressed Air and Tower based elevating facilities, suggest utilizing energy for electric alternator, moreover, Compressed Air, Flywheel Kinetic or fossil fuel Combustion Engines, although those systems generally fail to provide sufficient rates of electricity as well as RESIDUAL HOT WATER AND SPACE HEATING with high efficiency and high energy for various consumers especially in urban areas such as for example those disclosed in: US20070120430A1, GB2434039A, U.S. Pat. Nos. 6,791,225B2, 4,538,079A, US20030029269A1, U.S. Pat. Nos. 6,784,562B2, 6,006,519A, US20100283350A1, U.S. Pat. Nos. 8,850,791B2,8,950,377B2. Thereby, they are unable to be used as an actual energy power source core for the implementation of an Electric Compressed Air Storage, they have another major drawback, as they are lack the ability to supply long period energy supply duration and simultaneously with the same Storing Energy, compared to innovative and revolutionary breakthrough Air compressor generate Residual Hot Water and pre-pressurized Air/Water/Steam, to generate Hydrogen integrated with Hybrid Peripheral Multiple Expanding Chambers in Flywheel Compressed Air, Hydrogen explosion/combustion Engine and Hybrid Peripheral Multiple Expanding Chambers in Flywheel Compressed Air, Water/Steam Engine Energies supplies to various consumers. Thereby they are able to be used as an actual energies power source core for the implementation of a Peripheral multiple Expanding Chambers in Flywheel Engine, integrated with Electric Generator/alternator or mechanical output, powered by: Compressed Air and residual heat for Hydrogen generation, Solar Thermal generation, Water Energies Storage and Energies Supplies PCFEEGCAHSTWESES facility.

Moreover, few typical Peripheral multiple Expanding Chambers in Flywheel Engine, integrated with Electric Generator/alternator or mechanical output, powered by each of which is used for accommodate one or more Compressed Air (with Residual Hot Water), Hydrogen generation, Solar Thermal generation, Water Energies Storage and Energies Supplies PCFEEGCAHSTWESES facility, greatly improves the various Energies power supply, are capable to be installed above buildings and Multiple EV charging/discharging station for charging battery of an plug-in EV, as well as Hybrid Compressed Air or Air and Hydrogen integrate Air Compressor. Vehicles are capable of relatively demand high rates/Booster of covering the entire energies (as of the date of the present patent application). This obviously describes a strong and available source of Energies for everyday Electricity or mechanical output and Thermal consumers. For sake of comparison, a typical apartment consumes an average of Electricity ˜15-30 kWh/day and Hot Water ˜8 KW/Day, moreover, heating open space (winter period) ˜30-40 kWh/day of Thermal energy uses, when considering both AC and DC electrical power. It would be immensely advantageous to have a system capable of utilizing the electric power stored/accumulated/exchange relies on Air, Hydrogen, Steam, Hot Water tanks/accumulators, integrated with the PCFEEGCAHSTWESES facility, covering the entire systems demands, which operated as balance and Energies Booster supply to consumers in the immediate vicinity and cluster EVs and other consumers, as wheel as power to plurality of various energies consumer devices, domestic appliances, buildings, etc.

Other objects and advantages of this invention will become apparent as the description proceeds.

### SUMMARY OF THE INVENTION

The present invention relates to an Flywheel Engine utilizing flywheel with Peripheral multiple Expanding Chamber, facing towards the tilting of multi-stage conical Jets Booster, integrated with Electric Generator/Alternators or mechanical output, powered and defined by each of which is used for accommodate one or more Compressed Air, and residual heat for Hydrogen, Solar Thermal generation, Water Energies Storages and Energies Supplies creating the PCFEEGCAHSTWESES facility for supplying Electricity. Thermal Energies and mechanical energy output supplied from a plurality of Hybrid PV Thermal solar panels, as well as additional alternatively of High Pressure erected/patterned of Mixing Air/Water in to Multiple Conical Jets Booster, define as Steam Sunray collector apparatus, moreover, a Hybrid Air Compressor generate Residual hot Water, wherein energy sources are combined together and concentrating into highest Multiple Energies Supply of 880% through one or more configured PCFEEGCAHSTWESES facility, defined as Centralized Energies of: generations, storages and supplies, wherein each Electric Compressed Air, and residual heat for Hydrogen Solar Thermal generation, Water Energies Storages and Energies Supplies integrate Electric Generator/alternator creating PCFEEGCAHSTWESES facility, are adapted to Store Electric, Thermal, Compressed Air and Hydrogen Energies and Generate Electricity, Residual Hot Water, Compressed Air and Hydrogen to supply high Energies in a continues manner even during the breakdown/night, thereby enabling to use each of said PCFEEGCAHSTWESES facility for using various renewable Energies (at least partly)/exchange a plurality of Solar Electric and Thermal or grid Energies for Store the Energies, defines multiplications of those energies supplies several times for any demand for various consumers, as well as, Hybrid Compressed Air or Air and Hydrogen or integrate Air Compressor various Vehicle.

According to an embodiment of the invention, comprising with Pressurized system of Water with Air (as said “Aeration”) erected/patterned Venturi system, integrated pressurizing pump of Water/Air and additionally accommodating High Air pressurizer mixing, configured into Multiple Conical Boosters to Solar Steam generation collector, generate Residual High pressurized Solar Steam combine Pre-Compressed Air to generate Hydrogen generation, which create multiples improvements of: Electricity, Hot water, Heat, utilizing Residual Hydrogen generation Energies, Energies Storage and Energies Supplies, each of which is used for accommodate Peripheral Expanding multiple Chambers in Flywheel Engine, integrated with Electric Generator or mechanical output to various consumers, configured to charge/discharge Hybrid Compressed Air or Air and Hydrogen or integrate Air Compressor various Vehicle and other consumers.

According to an embodiment of the invention, the Peripheral multiple Chambers in Flywheel Engine integrated with Electric Generator or mechanical output, powered by Compressed Air, Hydrogen generation, Solar Thermal generation, Water Energies Storage and Energies Supplies PCFEEGCAHSTWESES facility, integrated and comprises plurality of Ultra Hybrid PV Thermal and PV panel and Fourth energies Hybrids CAHWSESES, increasing the plurality Energies power capacity in the plurality apparatuses, in hot or sunny climate areas, of which accommodating a bidirectional hot water pipes system for cooling (as Hybrid Air Condition), and respectively supplying hot water for domestic or commercial usages, wherein the water is heated by the Residual Hot Water unit and supplied via hot water heat exchanger unit through pipes.

According to an embodiment of the invention, the Peripheral multiple Expanding Chambers in Flywheel Engine integrated with Electric Generator or mechanical output, powered by Compressed Air, Hydrogen generation, Solar Thermal generation, Water Energies Storage and Energies Supplies PCFEEGCAHSTWESES facility, are located at an urban environment near the buildings/consumers, in order to increase and multiplies energy storage of DC or AC generating electric powers supply. Take advantage from exist electricity high voltage electricity grid energy supply, installing Peripheral multiple Expanding Chambers Flywheel Engine integrate Electric Generator or mechanical output, powered by Compressed Air, Hydrogen generation, Solar Thermal generation, Water Energies Storage and Energies Supplies PCFEEGCAHSTWESES facility, and reusing by multiplication the energies electricity to accommodate operate/charge the systems PCFEEGCAHSTWESES facility from those locally (nearby) high voltage cables to Micro-Grid, adapted to continuously connect/supply power electric/energies to various energies to the one or more consumers.

According to an embodiment of the invention, Peripheral multiple Expanding Chambers in Flywheel Engine integrated with Electric Generator or mechanical output, powered by Compressed Air and residual heat, Hydrogen generation, Solar Thermal generation, Water Energies Storage and Energies Supplies PCFEEGCAHSTWESES facility, wherein various energy sources are accommodate to one or more of the followings:
Any places in the worlds request/use various Energies as: Hot Water, Heating, Electricity and Peripheral Multiple Expanding Chamber in Flywheel Engine.
urban structures and environmental locations, including buildings, streets, traffic light junctions, squares, poles: light poles, greenery, among nature and artificial shaped assets.

According to an embodiment of the invention, the Peripheral multiple Expanding Chambers in Flywheel Engine integrated with Electric Generator or mechanical output, powered by Compressed Air, Hydrogen generation, Solar Thermal generation, Water Energies Storage and Energies Supplies PCFEEGCAHSTWESES facility, further comprises a management software tool for managing Ultra-Hybrid PV Thermal Energy and AC energy power generation, which using residual compressed high pressure Air, partly converted to Water used generating Hydrogen and is adapted to continuously supply high pressure energy storage and generate electricity and hot water to various consumptions, services and applications usages.

### BRIEF DESCRIPTION OF THE DRAWINGS

In the drawings:

FIG. 1 schematically illustrates an Peripheral multiple Expanding Chambers in the form of a hole with open end cut, characterized by structure of a triangle Arc and rectangular, facing towards the tilting of conical jets booster in the Flywheel Engine, integrated with Electric Generator or mechanical output, powered by each of which is used for accommodate one or more Compressed Air, Hydrogen generation, Solar Thermal generation, Water Energies Storage and Energies Supplies PCFEEGCAHSTWESES facility, furthermore, comprising plurality of consumers, and which is configured for continuously consume Solar and Grid Energy, integrated with CAHWSEStorage (Compressed Air Hydrogen generation, Water Steam generation, Energy Storage) and Electric Generator integrated Ultra Hybrid PV Thermal and Fourth Hybrid Peripheral Multiple Expanding Chambers in the form of a hole with open end cut, characterized by structure of a triangle Arc and rectangular, facing towards the tilting of the liquid conical jets, wherein the tilt angle is approximately 25° tangent to peripheral arc, and respectively perpendicular to the center axis connected to Flywheel, according to an embodiment of the invention;

FIG. 2 schematically illustrate detailed Energy Comparison (Example) present the multiple highest Efficiency Energies (power) of Peripheral Multiple Expanding Chambers in Flywheel in the form of a hole with open end cut, characterized by structure of a triangle Arc and rectangular, integrated Multi-stage Conical Boosters Energies, respectively multiple chambers are feed from Air Compressor integrated with Residual heat recovery, pressurizing multi-stages conical boosters, those low energies consumptions, significantly create high efficiency, according to an embodiment of the invention;

FIG. 3 schematically illustrates a Peripheral Expanding Chamber in the form of a hole with open end cut, characterized by structure of a triangle Arc and rectangular in Flywheel Engine, using Air or Air and Hydrogen explosion/combustion Engine or Water or Steam Engine combine with Electric Generator/Motor/Alternator and optional Clutch connected to Mechanical output systems and Generate Electricity, comprising plurality of static multi-stages conical boosters connected to chambers, respectively formed overlapping to each other in a Triangular Arch/Rectangular structure rotating with Flywheel with Peripheral Multiple Expanding Chambers, according to an embodiment of the invention;

FIG. 4 schematically illustrates a front Local doted View A FIG. 3 and zoom in Local Doted View 401 402-403-404 of Local doted View A FIG. 3, according to an embodiment of the invention;

FIG. 5 shows Flowchart of Peripheral multiple Expanding Chambers in Flywheel Engine integrated with Electric Generator or mechanical output, powered by Compressed Air Hydrogen Solar Thermal Water Energies Storage and Energies Supplies PCFEEGCAHSTWESES facility. Wherein each comprises “Hot Water, Compressed Air and Hydrogen producer, Electric reservoir”, adapted to be Energies charging and Energies discharge to supply high Energies in continues manner even during cloudy days and night, according to an embodiment of the invention;

FIG. 6 shows CAHWSEStorage and Electric Generator Versus Batteries Competitive advantages and Hybrid Air or Air and Hydrogen Peripheral Multiple Expanding Chambers in Flywheel explosion/combustion Engine and Electric Generator, versus as said Fuel Engine; and

FIG. 7 show calculations of energy consumption and energy power generating, using Hybrid compressor with Residual heat Energy generating Peripheral multiple Expanding Chambers in Flywheel Air Engine, integrated with Electrical Generator, according to an embodiment.

### DETAILED DESCRIPTION OF THE INVENTION

The present invention describes a stand-alone Electric Compressed Air, Hydrogen generation, Solar Thermal generation, Water Energy Storage and Peripheral Multiple Expanding Flywheel Engine Electric Generator ECAHSTWESFEEG facility, adapted to receive electrical DC power from Ultra Hybrid PV Thermal or PV solar panels pattern such as collectively solar PV panels, hot water/Steam Sunray collectors and etc., as well as, Energies supplies from the Grid/network.

The following approach describes a breakthrough new plurality of an Peripheral multiple Expanding Chambers in Flywheel Engine, integrate Electric Generator or mechanical output, powered by each of which is used for accommodate one or more Compressed Air, Hydrogen generation, Solar Thermal generation, Water Energies Storage PCFEEGCAHSTWES facility, integrated and comprises plurality of Ultra Hybrid PV Thermal, PV panel and Fourth energies Hybrids CAHWSESES Peripheral Multiple Chambers in Flywheel Engine Electric Power, respectively, through mechanical output.

The following approach, describes a novel CAHWS Energies Storage combines Energies Supplies technologies for Peripheral Multiple Expanding Chambers in Flywheel Engines, using Compressed Air and using Residual Water for Hydrogen, Steam resolve the dependency on a Heat-Pump and fossil fuel combustion Engines. In general, CAHWS Peripheral Multiple Expanding Chambers in Flywheel Engines have huge advantages as far as various implementations and uses are concerned, as motor oil, oil filter, fossil fuel, multiple parts (approximately 2,300 parts), automatic/mechanical shift gear and maintenance can be unused. Additionally improves the weight transmission and speed up Air Hydrogen charging period significantly. Moreover, can supply energies in Very hot areas by using the Water configuring Aerations erected with Venturi, integrated pressurizing pump of Water and Air, and additionally integrate High Air pressurizer mixing into Multiple Conical Jets Booster, define as a collector for Solar Steam generation.

The rotation of the flywheel, is actuated through its Peripheral Multiple Expanding Chambers, coupled to plurality of multi-stages conical jets booster, comprising multiple static chambers, positioned around an outer peripheral arc of the flywheel, wherein the static chambers having an opening configured such that upon rotation of the flywheel, there exists an overlap configuration, wherein the opening of the peripheral expanding chambers overlap the opening of a static chambers and multi-stages conical jets booster, creating the elongation between the chambers and the conical jets static chambers. the new revolutionary approach is ideal for any kind of various Energies consumers and allows free selection of combinations. Standard methods and the new revolutionary CAHWS Engine will be compared in the following.

The Peripheral multiple Expanding Chambers in Flywheel Engine, integrated with Electric Generator or mechanical output, powered by: Compressed Air, Hydrogen, Solar Thermal, Water Energies Storage PCFEEGCAHSTWES facility, provides energy optimization up to 80% and more, Energy Storage and Electric supply, Hot Water, drink Water, increasing energy efficiency for Hydrogen Generation. The Solar Hybrid Energy absorptions are converted proportionally to multiplications of energy generation. Thanks to multiple energies, the system combination process is accelerated, therefore, the advantage relies on the advantages and differences between the energy consumption of an Air compressor and the energy consumption of the PCFEEGCAHSTWESES. On the other hand, the heat temperature discharged from the air compressor also benefits from this. With a very small size, small foot print and Air/Electric/Steam consumptions relative to any existing systems/technologies, using about (e.g. 40,000 Litr 5-Bar Generate Electric ˜18 KW/h) Peripheral multiple Expanding Chambers in Flywheel Engine integrated with Electric Generator or mechanical output, powered by Compressed Air, Hydrogen generation, Solar Thermal generation, Water Energies Storage and Energies Supplies PCFEEGCAHSTWESES facility, therefore, they are extremely efficient, significantly improving this new approach and grants better efficiency transmission, plus unreached flexibility and durability compared to Lithium, Salt Acid Batteries or any air/water compressed systems, mechanical differential elevations of any conventional ones.

Thanks to the multiple various energy combinations, the systems can be used and there are no high requirements for the locations and installations. Furthermore, this method does not require any special equipment's or know how and can be assembled easily using the simplicity method. The PCFEEGCAHSTWESES facility method (does not require any special structure) and its flexible combination open up new possibilities for PCFEEGCAHSTWES facility applications.

Applying this method which capable to integrate a Multiple cooling throw the night/midnight operation with the Ultra Hybrid PV Thermal panels (patent 255843), alternatively enable to start new sunny day with restart cooling the hot water/steam in the Hybrid Energy Generator of High Pressure Air/Steam tanks partly exposed to SUN (H.E) systems, integrating with variety of focused sun angle, allowing a stronger Energy power.

In addition, electrical power is obtained/received from one or more forth energy storage of one or more Several Ultra Hybrid PV Thermal Panels or Mixed pressurized Air/Water Steam generation Sunray collectors apparatus, mounted on building roof or any other places, gathering energy and split to different channels are capable of providing, electrical AC or DC power to several power consumers, such as Residential, commercial buildings, instruments and domestic appliances which consume and will use Compressed Air, Hydrogen, generation Water and Steam generation Energies Storage and Energies Supplies (CAHWSESES) (e.g. domestic or public hot water, Air conditions, refrigerator etc.) via water supplied from the exist pressurized water grid and electric Locally grid and DC electrical outlets, as is known in the art.

The Peripheral multiple Expanding Chambers in Flywheel Engine integrated with Electric Generator or mechanical output, powered by Compressed Air, Hydrogen generation, Solar Thermal generation, Water Energies Storage and Energies Supplies PCFEEGCAHSTWESES facility, therefore, present invention is aimed at replacing the traditional electricity network and its power sources (i.e. electric power plants). The PCFEEGCAHSTWESES of the present invention is capable of providing sufficient Electrical and Thermal power to a large amount of Electric and Thermal consumers as well as Compressed A/H Vehicles and EVs. Simultaneously, enabling energy exchange between plurality energy consumers, as well as, adapted to be Energies charging and Energies discharge to supply high Energies in continues manner even during cloudy days and night, that enables to Receive, Store and Supply sufficient amount of various Energies power, and supplying energy sources of various forms and locations.

Furthermore, the CAHWSEStorage and Electric Generator, integrated Ultra Hybrid Bifacial PV Thermal and Peripheral Multiple Expanding Chambers in Flywheel Hybrids CAHWS Engine Electric Power Station, accommodating sun energy, comprises sufficient space for accommodating a plurality of systems and as will be described in further details.

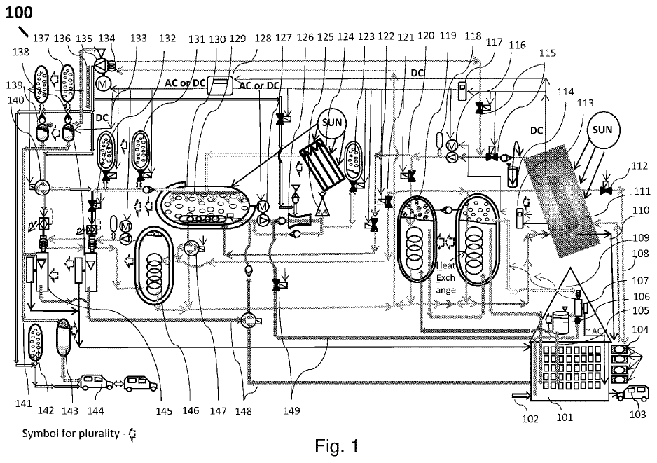

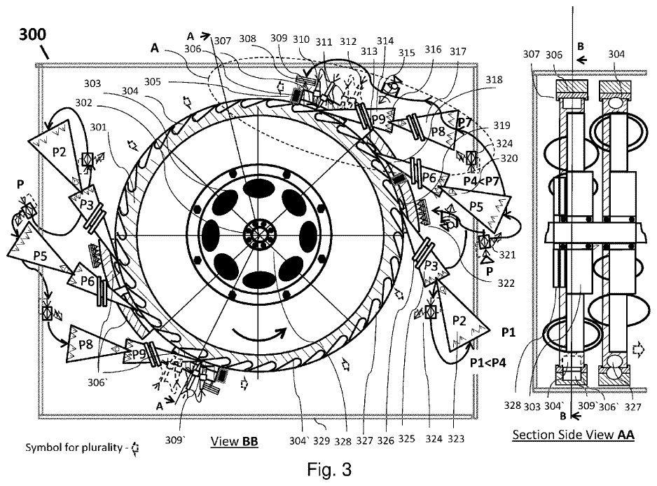

FIG. 1 schematically illustrates general view of renewable energies as well as Solar or Grid Energies are supply sources, comprising sufficient space for accommodate a plurality of an Peripheral multiple Expanding Chambers, in the form of a hole with open end cut characterized by structure of a triangle Arc and rectangular in Flywheel 301 (FIG. 3), overlapping with static chambers and conical fluids jets Engine/s, integrate Electric Generator/Alternator or mechanical output, powered by each of which is used for accommodate one or more Compressed Air Hydrogen generation, Solar Thermal generation Water Energies Storage and Energies Supplies PCFEEGCAHSTWESES facility, integrated and comprises plurality of Ultra Hybrid PV Thermal and PV panel 111, and Fourth energies Hybrids CAHWSESES Peripheral Chambers in Flywheel Engine Electric Power. The Peripheral multiple Expanding Chambers in Flywheel Engine integrated with Electric Generator or mechanical output, powered by Compressed Air Hydrogen generation, Solar Thermal generation, Water Energies Storage and Energies Supplies PCFEEGCAHSTWESES facility 100 of the present invention, are capable of providing a sufficient amount of energies power, accommodating configuration of Electric Storage or Thermal solar energies, configured by plurality of Hybrid PV Thermal and PV panels 111 incorporated with backup liquid compensation tank and as water relief pressure valve 114, may deploy through conduit to the Hybrid PV Thermal and PV panels 111, as well as water closed loop water circulation between heat exchanger in boiler 119 and UPVThermal Panel 111, that in order to balance the liquids and the thermal pressures reliefs that are created and connected through heat exchanger to hot water boiler 119, in its definition as a solar Third Hybrid CAWSE Peripheral Multiple Expanding Chambers in Flywheel Engine Energies Generators 107, combine with pressurized water supply from the network 102, occurs and creates a situation of delay in water flow and pressure, through water tanks pressure Buffer and Main water supply 106, may deploy throughout water gravity in pipes 105, to an exemplary implementation comprising: rooftop buildings, commercial, agriculture and Etc. consumers 101 and charge Electric Vehicles 103, as well as, supply pressurized hot Air/Water 109 to actuate the Third energies Hybrid CAWSE Peripheral Chambers in Expanding Flywheel Engine and Electric Generator 107, and continuously supply electricity DC or AC. Moreover, supply hot water to various consumers for hot water radiators and etc. (heating open space), wherein Sumer can also supply DC electricity 110 controlled by electric valve 112 and at the same time and alternatively, characterized by supply Residual hot water 108 to Hybrid A/C 104 (e.g. increase the A/C efficiency by ˜30%), the system controlled by differential controller 113 and closed loop water circulation pump 116, integrated with delayed pressure tank 118 create under pressure in the Hybrid PV Thermal top suction relative to the bottom 111. As well as, before all electrical systems and motors switch to use only DC electricity, the PV panels are connected to an Electric inverter DC/AC voltage converter together with energy management from the grid 117.

Simultaneously/alternatively additional system of CAWSE Flywheel Engine and Electric Generator 138, integrated hot Air/Water/Steam and plurality of solar Steam generation Sunray collectors, as solar Hybrid energy booster generators 124, respectively facing the SUNRAYS which is supplied by a Water/Air Booster pressure pump motor 127, mixed with Aeration of hot Water and pressurized Air from high pressure Hybrid apparatus Air compressor, which generating water from the condensation 135, as well as, characterized by Residual Hot Water 134 deploy through Pressurizing Multiple Conical Jets Booster 125, erected/patterned Venturi apparatus 126 connected to solar hot Steam generation Sunray collector, which is integrated and supplied by mixing Air and Water 124, as well as, characterized by and connected to internal pipe with differential holes 129, that creates a sprays towards the sides walls of the pressurized tank 130, in order to increase the effectiveness of the Steam that creates Steam Fog (SF), and increases the pressure in tank 130 which deploy Steam to form in an Air/Steam tank 130, integrated with One Way valve to increase the Steam generation pressure in the tank 131, avoid back pressure to be released to Air/Steam tank 130. In order to maintain air Pressure/Steam generation cycles in Air/Steam tank 130, the heat exchanger of tank 130 is connected through electrically controlled water valves 115, and electric valves 147 by the means of water to circulate through the Ultra Hybrid Bifacial PV Thermal and PV panel 111, and through water circulation pump 116 and Cool the Air/Steam in tank 130. It's occurred in the middle of the night towards morning, wherein lowering the tank temp 130 eventually supply sufficient amount to start new cycle at the next day. As well as, Residual heat can be transferred to the hot water tank 146 through the valve 147, which formed the hot water temperature to be maintained in the boiler 146, and from there the heat transferred to the heat exchangers in the CAHWSE, controlling through proportional pressure regulator 132 to Flywheel Engine and Electric Generator 138 and 145, as well as, air compressor 135 supply the high pressure, attached to it is a tray connected to liquid pipe 148 for accumulating liquids intended for recycling that goes to inlet of pressure pump motor 127, as well as liquid compensation through pipe and controlled valve 149.

In this embodiment, as well as and alternatively, characterized by pressurized Hydrogen generation apparatus 139, are capable receiving energy from Residual pressurized Water 136, created by the moisture/condensation in the compressor and partly from Residual pressurized Air, which is supplied from the Hybrid compressor 135 (Air compressor with Recovered Heat), as well as, if it is required to increase the need for Hydrogen, there is a combined option with Hydrogen pipe return at the air inlet to the pressure compressor, furthermore, integrated with High pressure Air Tank 137 (e.g. ˜40+80 Bar or 200:350 Bar). Wherein pressurized Hydrogen generation apparatus 139, receive sufficient amount electric power 133 from Hybrid PV Thermal or Standard PV panel, which deploying through a pipeline 141 to a pressurized Hydrogen storage and charging Hydrogen tank 143, as well as, receive a high pressure from Air tank 137, also used as a central multiple common share Storage/accumulate 142, for Hydrogen/Air charging various types of vehicles and etc. 144 (as said “refueling”).

In this embodiment, configured to centralize and distribute pressurized Air, pressurized Hydrogen, Electrical power, mixed Residual Steam and Residual hot water throughout Peripheral Multiple Expanding Chambers in Flywheel Engine, powered by Compressed Air, Hydrogen generation, Water and Steam generation for: Energies Storage (CAHWSES) combines Energies Supplies.

In Energy charging mode, Fourth energies Hybrids CAHWSESES Peripheral Multiple Expanding Chambers in Flywheel with Peripheral Engine, Electric and Energies Power Station facility 100, greatly improves the power supply of transferring the total high Air Hydrogen Steam, received preheated from Hybrid PV Thermal PV Panels 111, and combined with Hot Water/Air/Steam generation of Sunray Collector 124, and supplying to various forms array tanks 119 123 130 137 139 142 143 146. In a discharging mode, Fourth energies Hybrids CAHWSES Peripheral Multiple Expanding Chambers in Flywheel Engine, Electric and Energies Power Station facility 100, in various forms array splits and transfers High Voltage, compressed Air and compressed Hydrogen, received from a plurality Energy apparatuses to various consumers. This novel and unique structure enables continuous distribution of bidirectional various Energies throughout locally facility 100, comprising Fourth energies Hybrids CAHWSESES in continuous manner charge/discharge other plurality consumer. For demonstration, shows a situation where there are plurality energies exchanges in-between various consumers. alternatively, as well as, a variety of other forms e.g. various Vehicles, Buses, Trains, Ships, Air craft, Electric Generators, Fork lift and etc.

The Fourth energies Hybrids CAHWSESES, integrate with Peripheral Multiple Expanding Chambers in Flywheel Engine Electric and Energies Power Station facility 100, provides several advantages over ordinary Compressed Air Energy Storage and Electric Generator array facility, as it enables a continuous Air Hydrogen (A/H), Steam Energies accumulating and/or charging/discharging and/or exchange energies between A/H Vehicles or other consumers. Moreover, it provides Hybrid Compressed Air and compressed Hydrogen energy to A/H-Bus station or to Energies consumers in various forms array 144, from nearby facility 100 to “refueling” stations on which is built facility 100, its requires a user to perform a predefined action, such as enter a code (e.g., via a control panel or a mobile phone application), in order to bring a charging A/H Vehicles facility 100, include apparatus for data communication, as to enable to communicate and to remotely control 128 the operation of facility 100.

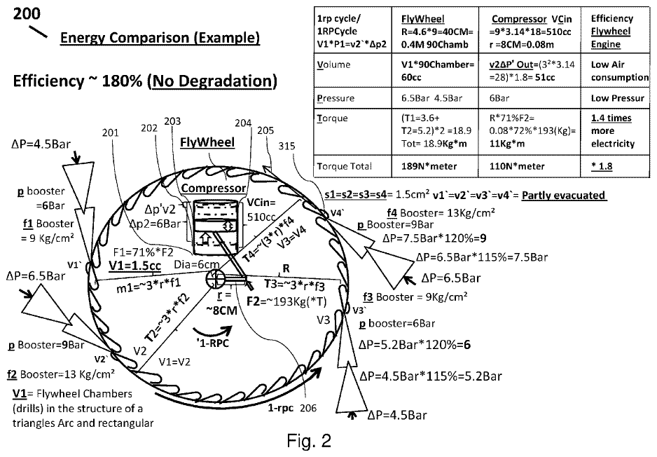

FIG. 2. Detailed Energy Comparison (Example) present the multiple highest Efficiency Energy (power) of: Flywheel with Peripheral Chambers ring integrated Multi-stage Conical Boosters Energy power, relative to Air compressor energy consumption integrated with Residual heat recovery, therefor, the excellent performance achieved by the Fourth energies Hybrids CAHWS, wherein Static Not or Partly Exhausted. Chambers divided into Triangle Arc and rectangular (except when using Hydrogen for explosion/combustion), integrates with the Peripheral Expanding Chambers divided into Triangle Arc/and rectangular rotating Flywheel. Moreover, the example in the illustration: refers to an Air Compressor with a piston and a cylinder 201, with a diameter of ˜60 cm which shows the position of the piston in the lower position 202, moving up and down 203 and reaching the highest point 204, the volume of Compressed Air described above relative to the arm at a distance R 206, wherein, Peripheral Expanding Multi Chambers in Flywheel Engine, indicate the distance of the Vector 205 and the thrust force, consist huge torque which are about 200%-800% (and more), much more greater relative to the center, as well as, the direction of the radial Vector thrust force of a hydrogen explosion/combustion Chambers relative to the center of the engine axis rotation is about ˜100% (and more), greater than a standard piston/wankel fossil combustion engine. To this we add the impact force and the thrust force of the Conical Jets Boosters compressed air, we get an addition as indicated in the table (multiplication of ˜500%). Everything described in the illustration of multiple explosions/combustion chambers (at least one or more) in the Flywheel Engine, refers to one cycle, while in a fossil combustion engine, the combustion action takes place in two cycles.

According to an embodiment of the invention, Fourth energies Hybrids CAHWSESES Peripheral Expanding Chambers in Flywheel Engine, integrates Electric to Power Station facility 100, is positioned in the proximity of charging/discharging Compressed Air, Compressed Hydrogen generation and Electricity in various forms array facilities stations.

FIG. 3 schematically illustrates as aforementioned detailed front and side view of: Hybrid CWE Peripheral Multiple Expanding Chambers in the form of a hole with open end cut, characterized by structure of a triangle Arc and rectangular, facing towards the tilting of conical Jets Booster in the Flywheel Engine and Electric Generator 107 (as seen in FIG. 1), When configured a new concept of extremely low volume of CAHWS Energy consumption, wherein the Ultra Hybrid CAHWSESES Peripheral Multiple Expanding Chambers, facing towards the tilting of the liquid conical jets in the Flywheel Engine 300, integrated with and Electric Generator 303, erecting CAHWSE Flywheel Engine and Electric Generator as CAWSE 138 and CAHE 145 (as seen in FIG. 1) comprising central axis with Bearings 302 connected to Flywheel with Peripheral chambers 301, combined with at least one and plurality of triangular arc/rectangular structure chambers 327, wherein the tilt angle is approximately 25° tangent to peripheral arc, respectively, perpendicular to the central axis with bearings 302 coupling with the flywheel 301, and relatively approximately 10° facing towards the tilting angle of the liquid conical Jets Booster 314, 318, integrated with Electric Generator 303, with optional clutch connected to mechanical output 328. Wherein, Flywheel with Peripheral chambers 301, comprising First Elongated Chambers in triangular arc/rectangular structure 327, and option for Second or more Elongated Chamber in triangular arc/rectangular structure 304, as well as more plurality configuration of Elongated Chambers in triangular arc/rectangular structure, where around the Flywheel Peripheral chambers 301, attached and divided into two or more and deployed through First Static Arc Bracket 306, maintaining the floating gap of approximately a micrometers for air fluids sealing and tenths of millimeter for water or liquids sealing, attached on of it and reinforced to the exterior bottom with low friction or touchless carbon graphite (or any Low friction material) 307, moreover, create Floating Air Cushion Structure with Silencers filters 305, integrated First Static Chamber divided into triangle Arc and rectangular chamber 319, Static chamber 319 in its definition with air pressure that is partially released, creates amplification within a curved rotation of the air in chamber 319, which creates a higher flow in Static chamber 319, which creates and exerts thrust and force on Flywheel Chamber 327, after which, it is re-pressurized to its previous situation between the chambers, and this until the two chambers separate from each other, when finally fluid pressure in Static Chambers Not or Partly Exhausted out normally they are recompressed (only form at first start and when needed with Air/Water/Steam to be refilled in any statics chambers). When configured to Second Stage Conical Jets Booster with an open elliptical (while drilling, the elliptical shape is obtained)/rectangular cross section for the fluids exit higher Pressure 325 (P3), supply sufficient amount high pressure integrate spiral heat exchanger 326, supply sufficient amount high pressure and Secondary Stage Lower pressure Conical Jets Booster 323 (P2), connected to controlled pressure regulator 324, Second Static Chamber divided into triangle Arc and rectangular 313 are not or partly exhausted out, normally they are recompressed (only form at first start and when needed with Air/Water/Steam to be refilled in any static chamber), connected to Second Stage Conical Jets Booster with an open elliptical/rectangular cross section for the fluids exit higher Pressure 318 (P6), supply sufficient amount high pressure when configured to First Stage Conical Jets Booster lower pressure 325 (P5), connected to controlled pressure regulator 324, wherein Third Static Chamber or Hydrogen internal Explosion/Combustion Chamber 309, integrate controlled Spark Plug ignition 310 and Hydrogen injector 311, connected to Secondary Stage Conical Jets Booster with an open narrow elliptical/rectangular cross section for the fluids exit Higher Pressure 314 (P9), integrate with spiral heat exchanger 326 connected to First Stage Lower pressure Conical Jets Booster 317 (P8), connected to controlled pressure regulator 324. Furthermore, in respectively with additionally balancing forces and frictionless opposing clamping, create the sliding seal of a Floating Air Cushion with pistons 322 and 308, controlled by Air/Hydrogen/Water/Steam/fluid control 315, to delay tightening the CAHWS as well as permanent bracket to keep approximately a micrometers gap for the Air, Hydrogen and gas sealing in various arrays forms.

On the opposite side, operate respectively same system of Second Static Arc Bracket Structure 306′, integrated Third Static Chamber divided into triangle Arc and rectangular 317′ and Forth Static Chamber divided into triangle Arch and rectangular 309′, the Second Arc Bracket Structure 306′ have the same components. Wherein another combination of a Hybrid CAWS (Air and Water) Peripheral Multiple Expanding Chambers Flywheel, overlapping with static chambers and fluids conical jets driven Electric Generator 107, without integrating Spark Plug 310 and Hydrogen injector 311 supplied from Pressurized Hydrogen generation system pipe line 312 (e.g. as indicated by numeral 139 in FIG. 1). An enclosure structure 329 combined with storage/accommodation of Air/Hydrogen hollow/Storage structure to support and strengthen the apparatuses, as well as to serve as compressed Air/Hydrogen generation storage, when the same concept will serve as a skeleton in a transport vehicle connected to at least one of Arc Bracket Structure 306.

Section Side View AA of Hybrid Fourth Energies CAHWSE and Electric Generator, present at least 2 combinations of Compressed Water Energy (CWE) Peripheral Multiple Expanding Flywheel Engine Electric Generator 107, Compressed Air Water Steam (CAWSE) Peripheral Multiple Expanding Flywheel Engine Electric Generator 138, and Compressed Air and Air/Hydrogen (CAHE) Peripheral Multiple Expanding Chambers in Flywheel Engine Electric Generator 145 (seen in FIG. 1) comprising, a construction 329 in a hollow/Storage structure to support and strengthen the assemblies, as well as, to serve as compressed Air/Hydrogen generation storage, when the same concept will serve as a skeleton in a transport vehicle connected to Arc Bracket Structure 306′ incorporating Electric generator 303, optional clutch 328 and option for Second or more Arc Bracket Structure 306′, incorporating Secondary or more Elongated Static Chamber in Triangular Arc/Rectangular structure 304′ and Second Chamber 309′.

According to an embodiment of the invention, Ultra-Hybrid Compressed Air, Hydrogen generation Energies (CAHE) Peripheral Multiple Expanding Chambers in Flywheel Engine 300, furthermore, comprising plurality of incorporating Compressed Air or Air and Hydrogen for vehicles, Buses, Trains, Ships, Air crafts Electric Generators, Fork lift etc.

### Sequence and System Operation Stages

To starting rotating the Flywheel with Peripheral Chambers 301, the chambers and each of which is used to accommodate one or more pressurized Air/Hydrogen/Water/Steam, respectively integrated with Multiples stages Conical Boosters are arranged in a structure and at distance, that incorporating initial sequence of pressure to start rotate the Flywheel Peripheral Chambers 301.
The pluralities multi-stage Conical Boosters are connected one after the other greatly improves the Energies power supply and consumes a differential pressure that rises relative to each other respectively in various forms array, furthermore, respectively with additionally connected/integrated hot heat spiral 326 to the Conical Jets Booster.
Flywheel with Peripheral chambers 301, coupled with at least one and plurality of triangular arc/rectangular structure chambers 327, forming the combination and rotation in overlapping between the Flywheel Chambers (at least one) and Static Chambers (at least one), impacts and thrust forces creating the rotation power for all different consumers, and/or combinations.

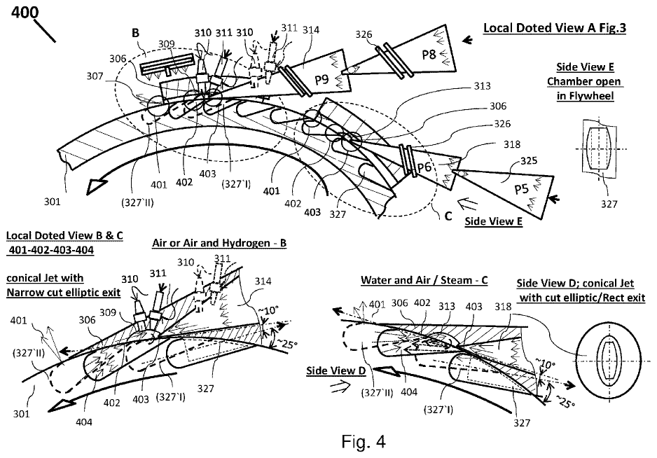

As described herein above FIG. 4, schematically illustrate views as indicated by the area within the boundaries of the dotted line A Ultra-Hybrid Compressed Air, Hydrogen generation Energies (CAHE) Peripheral Multiple Expanding Chambers combined and attached to fluid jets in the Flywheel Engine 300 (FIG. 3), First Static Arc Bracket 306, maintaining the floating gap of approximately micrometers for air/fluids sealing and tenths of millimeter for water or liquids sealing attached on of it and reinforced to the exterior bottom with low friction or touchless carbon graphite (or any Low friction material) 307 Structure, create Floating Air Cushion (touchless), wherein heat exchanger 326 that receives heat supply from the Residual heat flowing from high pressure compressor 135 heat exchanger 134 or from Air/Steam tank 130, or from Ultra Hybrid Bifacial PV Thermal panel residual heat 111 (FIG. 1) pressurizing First Stage Conical Jets Booster lower pressure 325 (P5 Combination with non-return valve to prevent back pressure), wherein Second Static Chamber divided into triangle Arc and rectangular 313 (P6), generating an pressurized Air/Water/Steam, suppling energy to rectangular/elliptic exit conical Jets Booster 318, creates a thrust force impact on the opposite wall of rotating chamber in the shape of triangle Arc/rectangular 327, after an initial rectangular/elliptic exit conical Jets Booster 318, impact force push the opposite wall chamber and filling the empty space of Chamber 327, creating a thrust force to the Flywheel with Peripheral Chambers 301, facing towards the tilting of the fluids which flow from conical jets, creates a flow and pressure in chambers 327, which causes thrust and counter return force, and in the same upper direction of the liquid jet at position 404, until and when the edges of the chambers spaces merge and separate from each other in position 402. at the end of this operation, the Flywheel Peripheral Expanding Chamber 327′I, moves respectively to another mechanism Stage of Conical Jets Booster with an open narrow elliptical cross section for the fluid exit higher Pressure 314 (P9), supply sufficient amount of pressure and relative to the lower pressure of the previous one (P6 its emerging, when the chamber is filled with a lower pressure of Air/Water/Steam P5), wherein the pressurized rectangular and elliptic exit/open of conical jet, impact a high force into Flywheel with Peripheral Chambers 301 triangle Arc and rectangular chamber opposite wall 327′I, generating Additional acceleration to Flywheel Peripheral Chambers 301, simultaneously, pressure is created between the two opposite walls chambers 327′I, and Static smaller Chamber or Hydrogen peripheral Explosion/Combustion Chamber divided into Triangle Arc and rectangular 309, creating increasing acceleration to Flywheel with Peripheral chambers 301. After this impact, incorporating with very high boost which added/received from Residual Hydrogen to Injection mechanism 311, and a Spark Plug ignited 310, creates Hydrogen impact and explosion forming acceleration which accelerates the Flywheel Peripheral Chambers 301, from here, Peripheral Chamber 327′II moves to the exhaust step, when the exploded/combusted air and Hydrogen that has been consumed in position 401 wherein the flow pass at overlap position 402, in addition, strengthens the Air/Hydrogen mixture at a higher pressure, fed from conical Jets Booster 314 (P9).

Local Dotted View B 401-402-403-404 highlighted and specifying Ultra-Hybrid Compressed Air Hydrogen Energies (CAHE) Peripheral Multiple Expanding Chambers Flywheel Engine, comprising configuration of multi-stage Conical Jets Booster 318, impact force and pushing the opposite wall of chamber 327, in overlap position 402 integrated with Static chamber 313, by means of air/fluid pressure that is partially released, creates amplification within a curved rotation of the air/fluid in chamber 313, which creates a higher flow in Static chamber 313, which creates and exerts thrust and force on Flywheel Chamber 327, after which, it is re-pressurized to its previous situation between the chambers and this until the two chambers separate from each other, when finally Air pressure in Static Chambers Not or Partly Exhausted. Peripheral Multiple Expanding Chambers Flywheel continue to rotate to the next Static chamber 309, accumulated with mixed high pressure Air and Hydrogen, by blowing the Static chamber 309 with the mixed A/H, ignition of the Spark Plug 310, creates an explosion followed by a thrust pressure in chamber 327′I that causes rotation in position 403, wherein, before the chambers 309 and 327′II start to separate in position 402, simultaneously chamber 327′II move to water/waste exhaust in position 401, wherein the volume of pressurized air/water begins to exhaust at position 401, simultaneously, conical Jets Booster with an open narrow in form of elliptical cross section for the fluid exit 314, start partly to push out the combust/pressurized air/water in rotating Flywheel Chamber 327′II and static chamber 309, as well as, respectively exhaust all combustion waste/leftover from the pressurized air/water, sucked out in the overlap position 402, furthermore, comprising plurality of system described above, form for a new concept of extremely light-weight, small space and small footprint Compressed Air and Hydrogen CAH Flywheel Engine, operates in various forms of Energies Supply as: Electric, Alternator and mechanical output.

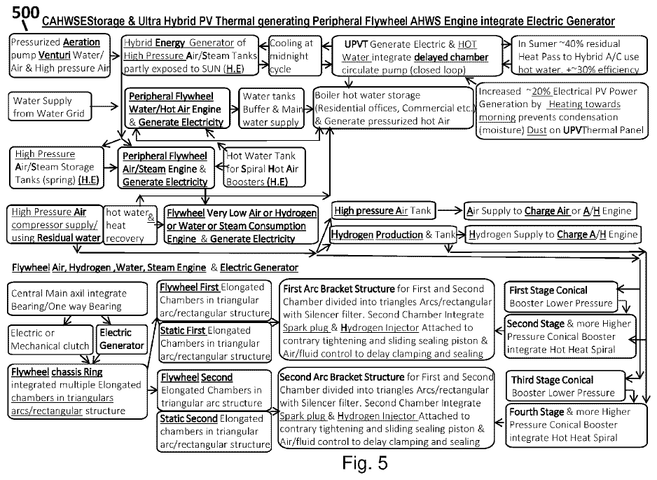

FIG. 5 schematically illustrates flow chart of Peripheral multiple Expanding Chambers Flywheel Engine, integrated with Electric Generator or mechanical output, powered by Compressed Air, Hydrogen generation, Solar Thermal generation, Water Energies Storage and Energies Supplies PCFEEGCAHSTWESES facility, and integrated Ultra Hybrid Bifacial PV Thermal comprising plurality versions. Wherein each comprises Hot Water, Compressed Air and Hydrogen production, Electric reservoir, adapted to be Energies charging and Energies discharge to supply high Energies in continues manner, even during cloudy days and night, which enables to Receive, Store and Supply sufficient amount of various power and Energies, and supplying energy sources of various forms and locations.

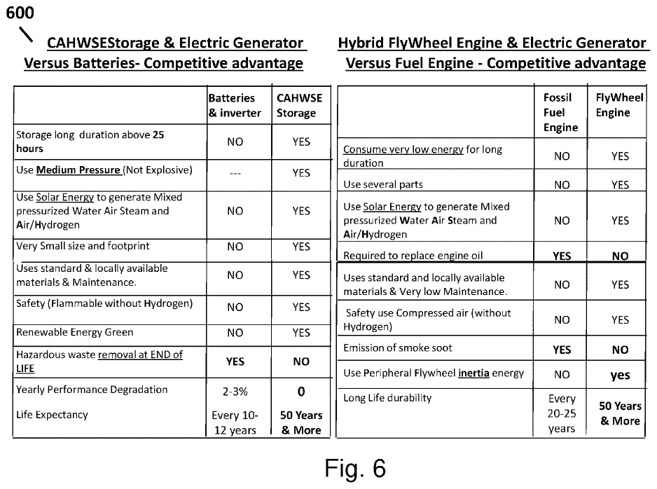

FIG. 6 Comparison tables of a:
Competitive advantages of renewable energies are suppling sources to CAHWSEStorage and Fourth Hybrid Peripheral Multiple Expanding Chambers in Flywheel Engine (CAHWS), integrate Electric Generator, versus plurality Batteries connected to DC/AC inverter.
Competitive advantages of renewable energies are suppling sources to Hybrid Air or Air and Hydrogen Peripheral Chambers in Flywheel Engine, integrated with Multi-stages Conical Jets Boosters integrate Electric Generator, versus fossil Fuel Engine.

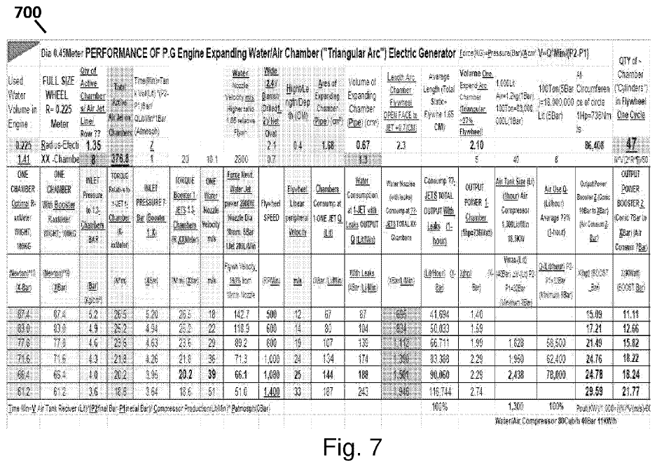

FIG. 7 schematically illustrates a (e.g. as shown in FIG. 2),
Calculations of performance of Peripheral Expanding of Multiple Chambers combined and attached to fluid jets in the Flywheel Engine Electric Generator.

Respectively reflecting the Energy consumption and Energy generation, integrated with Multi-Stages Conical Jets Boosters relative to Multi-Stage high pressure Air Compressor Energy consumption.

It is noted that although Peripheral multiple Expanding Chambers in the form of a hole with open end cut configuring a triangle arc/rectangular facing towards the tilting of liquid conical jets in the Flywheel Engine, integrated with Electric Generator/alternator or mechanical output, powered by each of which is used for accommodate one or more Compressed Air Hydrogen Solar Thermal Water Energies Storage facility, integrated and comprises plurality of Ultra Hybrid Bifacial PV Thermal, PV panel and Fourth energies Hybrids CAHWSESES (see FIG. 1), are illustrated with a specific number of Peripheral multiple Expanding Chambers in the form of a hole with open end cut, characterized by structure of a triangle Arc and rectangular in Flywheel Engine, integrated with Electric Generator or mechanical output, powered by Compressed Air Hydrogen generation, Solar Thermal Water Energies Storage and Energies Supplies PCFEEGCAHSTWESES facility, integrated and comprises plurality of Ultra Hybrid Bifacial PV Thermal, PV panel and Fourth energies Hybrids CAHWSESES, according to the present invention is not limited to a specific number of Peripheral multiple Expanding Chambers in Flywheel Engine integrated with Electric Generator or mechanical output, powered by Compressed Air Hydrogen, Solar Thermal Water Energies Storage and Energies Supplies PCFEEGCAHSTWESES facility, integrated and comprises plurality of Ultra Hybrid PV Thermal, PV panel and Fourth energies Hybrids CAHWSES and can comprise one or more, as explained hereinabove.

Although embodiments of the invention have been described by way of illustration, it will be understood that the invention may be carried out with many variations, modifications, and adaptations, without exceeding the scope of the claims.

1-13. (canceled)

14. A flywheel engine (300) generating and storing energy comprising: a flywheel (301) comprising multiple peripheral expanding chambers in the form of a hole with open end cut forming a shape of a triangle arc and rectangular (327), wherein the tilt angle is approximately 25° tangent to peripheral arc, respectively, perpendicular to the central axis (302), and relatively to tilting angle of approximately 10° facing towards the tilting of multi-stages conical jets booster (318); a arc brackets (306) coupled to plurality of multi-stages conical jets booster (314), comprising multiple static chambers (309), positioned around an outer peripheral arc of the flywheel (301), wherein the static chambers (309) having an opening configured such that upon rotation of the flywheel (301), there exists an overlap configuration, wherein the opening of the peripheral expanding chambers (327), overlap the opening of a static chambers (309) and multi-stages conical jets booster (314), respectively, forming the elongation in-between them; a floating gap of approximately tenths of a millimeter, seals the water or liquids between the chambers (327) adjacent to static conical jets booster (318) coupled to chambers (313) and; a floating gap of approximately micrometers, seals the air or air and hydrogen fluids between the chambers (327) adjacent to static conical jets booster (314) coupled to chambers (309), being integrated with controlled spark plug ignition (310) and hydrogen injector (311).

15. The flywheel engine of claim 14, wherein an air compressor with residual heat recovery (135), connected to first stage conical jets booster (323) for supplying compressed fluid at lower pressure to the second stage conical jets booster (325), the secondary stage conical jets booster (325) integrate with spiral heat exchanger (326), for feeding compressed fluid at higher pressure to peripheral expanding chambers (327).

16. The flywheel engine of claim 14, wherein the peripheral chambers (327), static chambers and multi-stage conical jets booster, have a structure selected from combinations of shapes with openings of: triangle arc, rectangular, elliptic.

17. The flywheel engine of claim 14, wherein direct impact and thrust force facing towards the tilting of the fluids which flow from conical jets, creates a flow and pressure in chambers (327), which causes thrust and counter return force, and in the same upper direction of the liquid jet at position (404) coupled to mechanical output power.

18. The flywheel engine of claim 14, wherein the peripheral chambers (327) are adapted to receive a compressed fluid from at least one of: air, hydrogen, condensed water, and steam.

19. The flywheel engine of claim 14 for use in at least one of generating electricity, generating residual hot water, generating compressed air, generating hydrogen, generating steam, storing electric energy, storing thermal energy, storing compressed air energy, storing hydrogen energy to supply energy electricity or mechanical output.

20. An apparatus (139) comprising an enclosure accommodating the flywheel engine according to claim 14.

21. The apparatus (111) of claim 20, comprising a solar PV electricity generation integrated with residual hot water, wherein renewable residual energies are supplying sources to a bidirectional hot water pipes system for cooling hybrid air condition, and respectively supplying hot water for domestic or commercial usages in various configuration of compressed air and hydrogen generation, electric reservoir, adapted to be energies charging and energies discharge to supply high energies in continues manner.

22. The apparatuses (124, 126, 130) according to claim 16, wherein combined and consist from mixing pressurized air and water, configuring aerations erected with venturi, generating steam.

23. The apparatus (142, 143, 144) according to claim 16, wherein coupled to one or more of: an independent parking, a charging, discharging or exchange compressed air and hydrogen station or facility, an urban structure selected from a building and a street, and a vehicle.

24. The apparatuses (111, 114) according to claim 18, wherein the delayed pressure tank (114) creates under pressure in the ultra-hybrid bifacial PV thermal panel (111), respectively between the top suction relative to the bottom.

25. The apparatus (111) according to claim 22 for use in improving the quick and easy cleaning, increasing electrical PV power generation by heating towards morning, preventing condensation of moisture and dust on UPV thermal panel comprising a closed loop water circulation between heat exchanger and UPV thermal panel.

26. The apparatus (128) according to claim 16, comprising management software tools and interface applications tool for managing energies of any one of: electricity, hot water generation, storage/accumulation, and supply/consumption, meters, billing, payment and balancing provision.
